(19) United States
(12) Patent Application Publication
(10) Pub. No.: US 2010/0017560 A1
(43) Pub. Date: Jan. 21, 2010

(54) MEMORY CONTROLLER, NONVOLATILE MEMORY DEVICE, ACCESS DEVICE, AND NONVOLATILE MEMORY SYSTEM

(75) Inventors: Tadashi Ono, Osaka (JP); Masahiro Nakanishi, Kyoto (JP); Isao Kato, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/440,988

(22) PCT Filed: Sep. 11, 2007
(86) PCT No.: PCT/JP2007/067664

§ 371 Date: Jun. 3, 2009

(30) Foreign Application Priority Data
Sep. 13, 2006 (JP) 2006-248345

(51) Int. Cl. G06F 12/00; G06F 12/02

(52) U.S. Cl. 711/103; 711/E12.001; 711/E12.008

(57) ABSTRACT

It has been difficult for an access device to obtain a remaining capacity of a memory from a nonvolatile memory device having a plurality of interfaces. A capacity parameter generation part 127 and a capacitor parameter notification part 128 are provided in a memory controller 120. When data is written or deleted, the capacity parameter generation part 127 generates a capacity parameter based on a physical region management table 125. The capacity parameter notification part 128 sends the generated capacity parameter to an access device 200. The access device 200 obtains a remaining capacity of the nonvolatile memory device 100 from the received capacity parameter.

### TECHNICAL FIELD

The present invention relates to a nonvolatile memory device such as a semiconductor memory card having a nonvolatile memory, a memory controller for controlling the nonvolatile memory device, an access device for accessing the nonvolatile memory device, and a nonvolatile memory system configured by adding the access device to the nonvolatile memory device.

### BACKGROUND ART

A nonvolatile memory device having a rewritable and nonvolatile flash memory as a main memory is increasingly demanded mainly for a semiconductor memory card. The nonvolatile memory device is high-price compared to an optical disk, media of tape, and the like, however, has merits such as small-size, lightweight, vibration resistance, and easy handling. Because of the merits, the nonvolatile memory device is increasingly demanded as a memory medium for portable apparatus such as a digital still camera and a personal computer.

This nonvolatile memory device has a memory controller for controlling a nonvolatile memory. The memory controller controls reading and writing of data to and from the flash memory in accordance with a reading command and a writing command from an access device, for example, a digital still camera and a personal computer. Meanwhile, there is not only a portable audio apparatus accepting the semiconductor memory card but also a portable apparatus internally mounting the flash memory. In these years, the semiconductor memory card is used not only for the aforementioned consumer use but also for a professional-use moving image recording apparatus for, for example, a broadcast station.

The flash memory incorporated in a product such as the semiconductor memory card and a portable audio apparatus requires relatively long time to write and read data to and from a memory cell array, that is, a recording unit. For this reason, the flash memory employs a constitution to enable data to be collectively erased and written from and to a plurality of memory cells. Specifically, the flash memory includes a plurality of physical blocks, namely, erasing units of data, and each physical block includes a plurality of physical pages, namely, writing units of data.

The access device side such as the digital still camera manages such nonvolatile memory device incorporated in or attached to the access device by using a file system, for example, a FAT file system. The FAT file system manages file data for each cluster by using a File Allocation Table (hereinafter referred to as FAT). When writing file data to the nonvolatile memory device such as the semiconductor memory card, the access device allocates the file data to an empty cluster, and designates the file data and a cluster number (a logical address) to which the file data is allocated to the nonvolatile memory device. For example, patent document 1 discloses a nonvolatile memory system employing such FAT file system in detail.

Meanwhile, with miniaturization and speeding-up of a wireless communication module, a nonvolatile memory device mounting a wireless communication function is put to practical use, and patent documents 2 and 3 disclose examples of such devices. When such nonvolatile memory device is used, a device other than the access device can also read and write data from and to the nonvolatile memory via a wireless interface.

FIG. 1 shows a configuration of a conventional nonvolatile memory system including a nonvolatile memory device having a wireless communication function. The nonvolatile memory system in FIG. 1 includes an access device 10, a remote device 20, and a nonvolatile memory device 30. The access device 10 includes an application 11 and a file system 12. The nonvolatile memory device 30 includes a memory controller 31, a wireless module 32, a nonvolatile memory 33, and a memory bus 34, and connects to the access device 10 via an external bus 40 and to the remote device 50 via a wireless communication channel 50. In this nonvolatile memory device, although the access device 10 has a file system, the nonvolatile memory device characteristically does not have a file system.

In the nonvolatile memory system, a case of writing data to the nonvolatile memory 33 of the nonvolatile memory device 30 via the wireless communication channel 50 from the remote device 20 will be considered. In this case, there is a method in which the wireless module 32 that received the aforementioned data directly supplies the received data to the memory controller 31 and the memory controller records the data to the nonvolatile memory 33 via the memory bus 34.

Meanwhile, there is a method in which data received by the wireless module 32 via the wireless communication channel 50 is once supplied to the application 11 of the access device 10 via the external device 40 and the application data 11 writes the supplied data to the nonvolatile memory 33 via the file system 12.

Patent document 1: Japanese Unexamined Patent Publication No. 2001-188701

Patent document 2: Japanese Unexamined Patent Publication No. 2002-358275

Patent document 3: Japanese Unexamined Patent Publication No. 2006-202336

### DISCLOSURE OF THE INVENTION

### Problems to be Solved by the Invention

However, there is a following problem in the nonvolatile memory system having the above mentioned wireless communication function and the like and using the nonvolatile memory device able to directly read and write data from and to an access device other than the presently connecting access device. In a case where file data was written on the basis of a file system of the remote device 20 without using the file system of the access device 10, the access device 10 cannot determine a file name (file ID) of the written data and a physical address storing the data in the nonvolatile memory. The access device 10 accordingly cannot read and delete the data written by the remote device 20. Additionally, since being unable to know a size of the recorded file data, the access device 10 cannot know an accurate remaining capacity of the nonvolatile memory device 30 and usability of the system seriously deteriorates.

In the case of once supplying data received by the wireless module 32 to the application 11 of the access device 10 via the external bus 40, the access device 10 can read and delete the aforementioned data because the same channel as that of an operation in which the access device 10 writes data to the nonvolatile memory 33 is used. However, in this method, data received from the remote device 20 shuttles in the external bus 40, resulting in increases of traffic and in deterioration of whole performance of the nonvolatile memory device and system.

The present invention is achieved in view of such conventional problems, and intends to provide a memory controller, a nonvolatile memory device, a nonvolatile memory system, and an access device each able to detect a remaining capacity of the nonvolatile memory device even in a case of using a plurality of the access devices.

### Means to Solve the Problems

To solve the problems, a memory controller according to the present invention which is connected to a nonvolatile memory having a plurality of physical blocks of a data erasing unit, and writes and reads data to and from said nonvolatile memory in accordance with a file ID designated from an outside, comprises: at least two external interfaces; a capacity parameter generation part for generating a capacity parameter related to a remaining capacity of said nonvolatile memory in writing data to said nonvolatile memory and deleting data in said nonvolatile memory via one of said external interfaces and in initialization; and a capacity parameter notification part for retaining the capacity parameter generated by said capacity parameter and notifying the outside of the capacity parameter via at least the other external interface.

At least one of said external interfaces may be a wireless communication interface for sending and receiving data by wireless communication.

The memory controller may further comprise: a mapping table for relating said file ID to said physical block.

Said memory controller may further comprise a reading-writing control part having a physical region management table representing a use state of said nonvolatile memory; said capacity parameter generation part may generate a capacity parameter by using said physical region management table; and said capacity parameter notification part may have a reference value used for detecting a certain amount of change of the capacity parameter and notify an outside of said generated capacity parameter when said generated capacity parameter changes exceeding said reference value from the retained capacity parameter.

Said memory controller may further comprise a reading-writing control part having a physical region management table representing a use state of said nonvolatile memory and a writing completion detection part for detecting completion of file data writing; and said capacity parameter generation part may generate a capacity parameter by using said physical region management table when said writing completion detection part detects said completion of file data writing.

To solve the problems, a nonvolatile memory device comprises: a nonvolatile memory having a plurality of physical blocks of a data erasing unit; and a memory controller, and stores and reads data in accordance with a file ID designated from an outside, wherein said memory controller includes: at least two external interfaces; a capacity parameter generation part for generating a capacity parameter related to a remaining capacity of said nonvolatile memory in writing data to said nonvolatile memory and deleting data in said nonvolatile memory both via one of said external interfaces and in initialization; and a capacity parameter notification part for retaining the capacity parameter generated by said capacity parameter and notifying the outside of the capacity parameter via at least the other external interface.

At least one of said external interfaces may be a wireless communication interface for sending and receiving data by wireless communication.

Said memory controller may further comprise: a mapping table for relating said file ID to said physical block.

Said memory controller may further include: a reading-writing control part having a physical region management table representing a use state of said nonvolatile memory; said capacity parameter generation part may generate a capacity parameter by using said physical region management table; and said capacity parameter notification part may have a reference value used for detecting a certain amount of change of the capacity parameter and notifies an outside of said generated capacity parameter when said generated capacity parameter changes exceeding said reference value from the retained capacity parameter.

Said memory controller may further include: a reading-writing control part having a physical region management table representing a use state of said nonvolatile memory and a writing completion detection part for detecting completion of file data writing; and said capacity parameter generation part may generate a capacity parameter by using said physical region management table when said writing completion detection part detects said completion of file data writing.

To solve the problems, a nonvolatile memory system according to the present invention comprises: a plurality of access devices; and a nonvolatile memory device for storing and reading data in accordance with a file ID designated from said access device, wherein: said nonvolatile memory device includes: a nonvolatile memory having a plurality of physical blocks of data erasing units; and a memory controller; and said memory controller includes: a plurality of external interfaces connected to said each access device; a capacity parameter generation part for generating a capacity parameter related to a remaining capacity of said nonvolatile memory when any one of said access devices writes data to said nonvolatile memory and deletes data in said nonvolatile memory both via one of said external interfaces and when initialization is executed; and a capacity parameter notification part for retaining the capacity parameter generated by said capacity parameter and notifying other access device of the capacity parameter via at least the other external interface.

At least one of said external interfaces of the memory controller may be a wireless communication interface for sending and receiving data by wireless communication.

At least one of said access devices may be a remote device for sending and receiving data by wireless communication.

Said memory controller may further include: a mapping table for relating said file ID to said physical block.

Said memory controller may further include: a reading-writing control part having a physical region management table representing a use state of said nonvolatile memory; said capacity parameter generation part may generate a capacity parameter by using said physical region management table; and said capacity parameter notification part may have a reference value used for detecting a certain amount of change of the capacity parameter and notifies said access device of said generated capacity parameter when said generated capacity parameter changes exceeding said reference value from the retained capacity parameter.

Said memory controller may further include: a reading-writing control part having a physical region management table representing a use state of said nonvolatile memory and a writing completion detection part for detecting completion of file data writing; and said capacity parameter generation part may generate a capacity parameter by using said physical region management table when said writing completion detection part detects said completion of file data writing.

To solve the problems, an access device according to the present invention used by being connected to a nonvolatile memory device having at least two external interfaces and a nonvolatile memory, reads and writes data by designating a file ID to said nonvolatile memory device, receives a capacity parameter from said nonvolatile memory device, and calculates a remaining capacity of said nonvolatile memory device by using said capacity parameter.

Said access device may send and receive data by wireless communication.

### Effectiveness of the Invention

According to the present invention, in a nonvolatile memory system premising an “access method based on a file ID” in which an access device designates file data to be read from or written to a nonvolatile memory device by using the file ID, when file data is written to the nonvolatile memory device via a wireless access device and the like, an access device other than the wireless access device can handle the file data. In addition, since the nonvolatile memory device appropriately generates a capacity parameter related to a remaining capacity of a nonvolatile memory and notifies the access device of the parameter, the access device other than the wireless access device can accurately obtain a present remaining capacity of the nonvolatile memory even in a case where the wireless access device wrote or deleted the file data.

### BRIEF DESCRIPTION OF DRAWINGS

FIG. 1 is a block diagram showing a configuration of a nonvolatile memory system having a conventional wireless communication module.

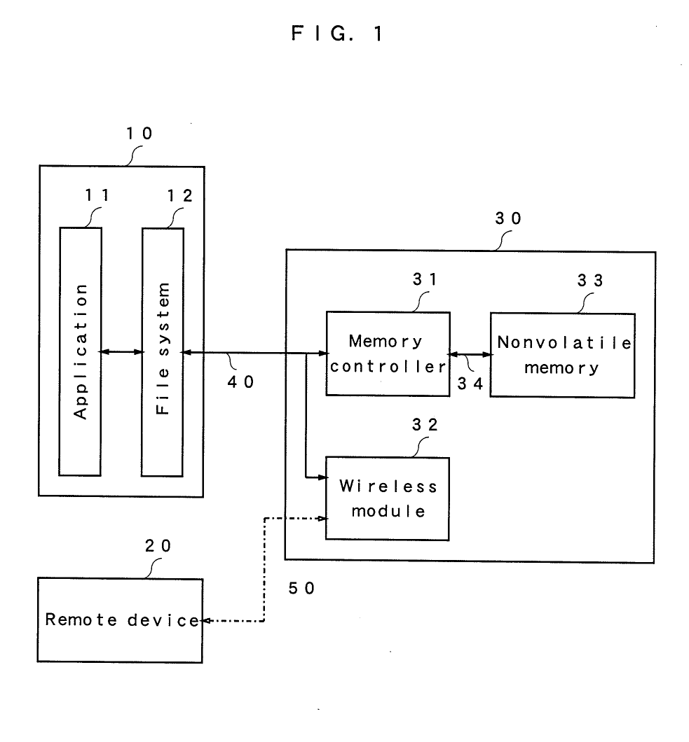

FIG. 2 is a block diagram showing a configuration of a nonvolatile memory system in embodiment 1 of the present invention.

FIG. 3 is a memory map showing a physical region management table.

FIG. 4 is a memory map showing a mapping table.

FIG. 5A is an explanation view showing a linking state of physical blocks storing file data.

FIG. 5B is an explanation view showing a linking state of physical blocks storing file data.

FIG. 6 is a flowchart showing an operation of embodiment 1.

FIG. 7 is a block diagram showing a configuration of a nonvolatile memory system in embodiment 2 of the present invention.

FIG. 8 is a flowchart showing an operation of embodiment 2.

### EXPLANATION FOR REFERENCE NUMERALS

100, 160 Nonvolatile memory device

110 Nonvolatile memory

120, 150 Memory controller

121, 203 Interface

122 Wireless communication interface

123 Interface detection part

124, 140 Reading-writing control part

125 Physical region management table

126 Mapping table

127, 129 Capacity parameter generation part

128 Capacity parameter notification part

141 Writing completion detection part

200 Access device

201, 301 User interface

202, 302 Application

210 External bus

300 Remote device

303 Wireless communication interface

310 Wireless communication channel

### BEST MODE FOR CARRYING OUT THE INVENTION

### Embodiment 1

A nonvolatile memory system in the present embodiment premises an “access method based on a file ID” in which an access device designates the file ID of file data instead of conventional designation of a logical address when the access device reads or writes file data from or to the nonvolatile memory device. The file ID is information used for identifying the file data, and a file number is used as the file ID in the present embodiment.

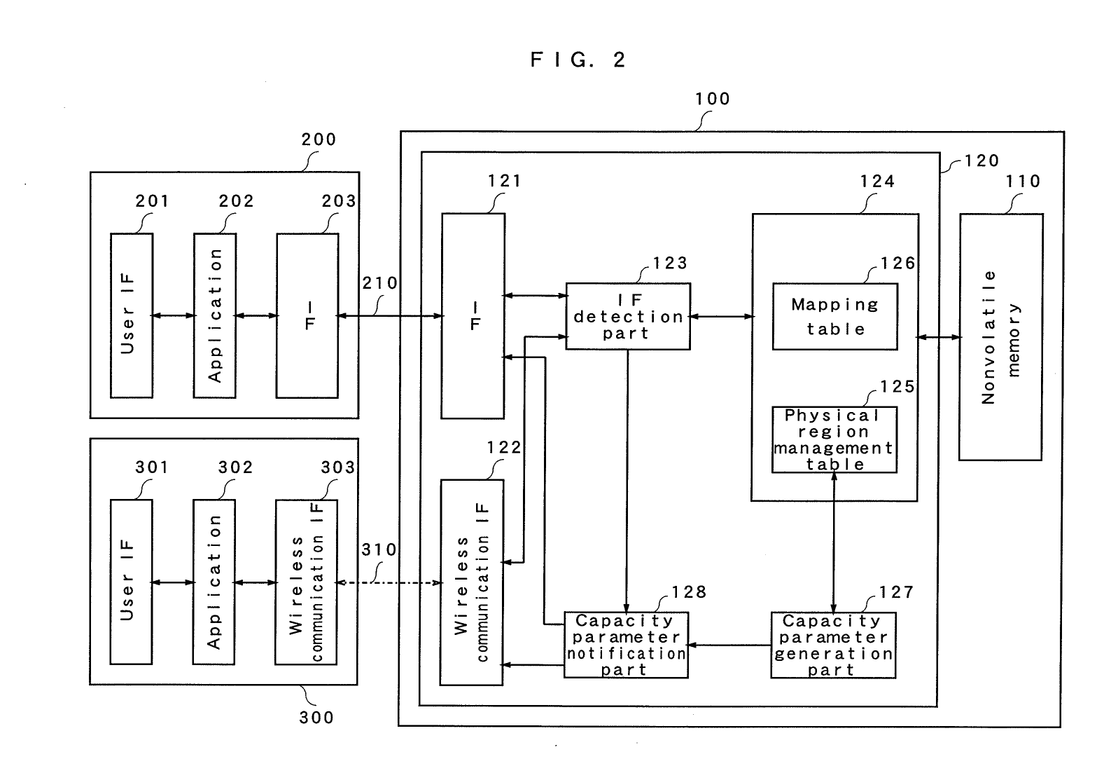

FIG. 2 is a block diagram showing a nonvolatile memory system in embodiment 1 of the present invention. The nonvolatile memory system in the present embodiment includes a nonvolatile memory device 100, an access device 200, and a remote device 300. The nonvolatile memory device 100 and the access device 200 are connected each other via an external bus 210. In addition, the nonvolatile memory device 100 and the remote device 300 are connected each other via a wireless communication channel 310.

The nonvolatile memory device 100 includes a nonvolatile memory 110 and a memory controller 120, and the nonvolatile memory 110 and the memory controller 120 are connected each other via a memory bus.

The nonvolatile memory 110 is a nonvolatile flash memory, and includes a plurality of physical blocks (PB) which are erasing units of data. A size of the physical block in the embodiment is, for example, 256 kbytes(kB). For example, when a size of the nonvolatile memory 110 is 1 GB, the nonvolatile memory 110 has 4096 physical blocks from PB1 to PB4096.

The memory controller 120 includes an interface (IF) 121, a wireless communication interface (IF) 122, an interface (IF) detection part 123, a reading-writing control part 124, a capacity parameter generation part 127, and a capacity parameter notification part 128. On the basis of an order from the access device 200 or the remote device 300, the memory controller 120 writes data to the nonvolatile memory 110, read data from the nonvolatile memory 110, and sends the data to the access device 200 or the remote device 300. The memory controller 120 additionally generates a parameter used for calculating a remaining capacity of the nonvolatile memory 110 and sends the parameter to the access device 200 or the remote device 300.

The interface 121 receives the file number used for writing and reading file data to and from the access device 200, and sends and receives the file data and command data to and from the access device 200 via the external bus 210.

The wireless communication IF 122 receives the file number of file data to be written and read from the remote device 300, and sends and receives the file data and command data to and from the remote device 300 via the wireless communication channel 310.

The IF detection part 123 carries out an exclusive access control so that either one of the interface 121 and the wireless communication IF 122 can send and receive data. In addition, the IF detection part 123 sends and receives data to and from the interface 121 and the wireless communication IF 122, and detects which one of the interfaces is used and notifies the capacity parameter notification part 128 of that result.

The reading-writing control part 124 internally has a RAM, and generates a physical region management table 125 representing a use state of the nonvolatile memory 110 and a mapping table 126 representing physical block numbers storing data for each file number on the RAM. The reading-writing control part 124 receives a file number and file data from the IF detection part 123, and writes the received file data to the nonvolatile memory 110 on the basis of the file number. In addition, the reading-writing control part 124 reads file data from the nonvolatile memory 110 on the basis of the file number received from the IF detection part 123, and outputs the file data to the IF detection part 123. Moreover, the reading-writing control part 124 outputs a block status in the physical region management table 125 to the capacity parameter generation part 127.

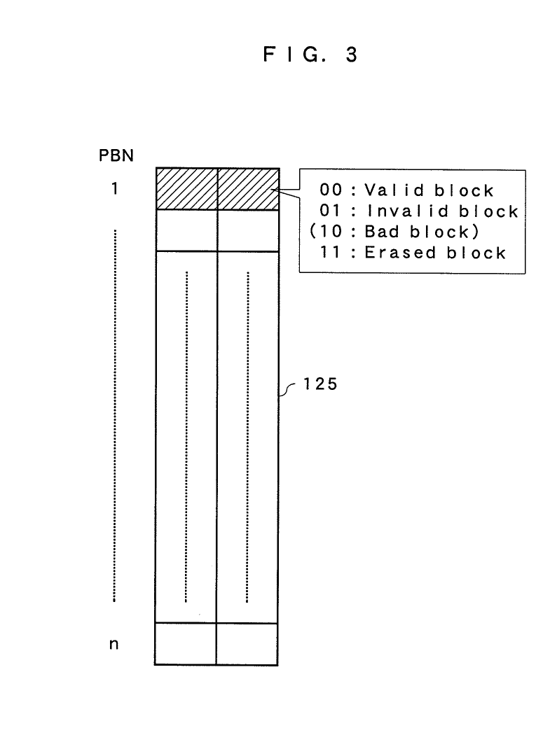

FIG. 3 shows the physical region management table 125. The physical region management table 125 retains a state of physical block of each physical block number as a block status. A value “00” represents a valid block storing valid data, and a value “01” represents an invalid block storing invalid data and being able to newly store data if the invalid data is erased. A value “10” represents a bad block that is not able to store data because of, for example, breakage of memory cell, and a value “11” represents an erased block in which all data was erased and that is able to newly store data. To simplify the description, the embodiment with no bad block will be explained.

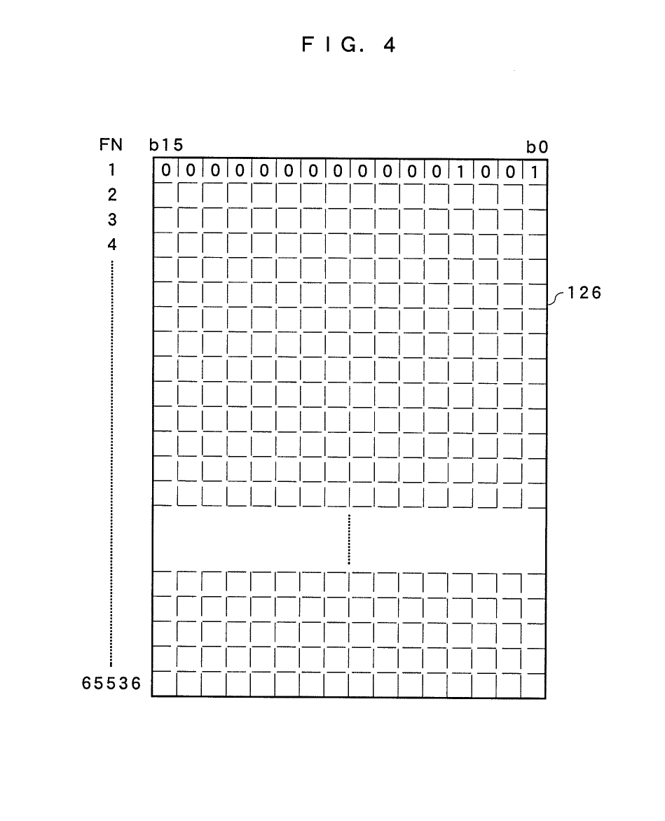

FIG. 4 shows the mapping table 126. For each file number of file data stored in the nonvolatile memory 110, the mapping table 126 shows a physical block number storing the file data. FIG. 4 shows that physical block PB9 stores file data of file number 1.

The capacity parameter generation part 127 generates a capacity parameter used for calculating a remaining capacity of the nonvolatile memory 110 with using a block status obtained from the physical region management table 125, and outputs the parameter to the capacity parameter notification part 128.

The capacity parameter notification part 128 stores the capacity parameter received from the capacity parameter generation part 127, and judges whether or not the capacity parameter must be sent with using a boundary value p(i) (i=0, 1, 2, . . . ) for the capacity parameter. The capacity parameter notification part determines whether the capacity parameter must be sent to the access device 200 or the remote device 300. The boundary value is a reference value used for detecting a certain amount of change of the capacity parameter.

The access device 200 includes a user interface (IF) 201 having a display function, an application 202, and an interface (IF) 203. The access device 200 orders the nonvolatile memory device 100 via the interface 203 to send and receive file data.

The remote device 300 includes a user interface (IF) 301 having a display function, an application 302, and an interface (IF) 303, and orders the nonvolatile memory device 100 via the wireless communication IF 303 to send and receive file data.

The display functions of the user IFs 201 and 301 display information, for example, a remaining capacity of the nonvolatile memory device 100.

The nonvolatile memory system of the embodiment configured as described above will be explained separated into initialization processing in starting up a power source and processing in data writing from the remote device.

[Initialization Processing in Starting-Up a Power Source]

At first, the initialization processing in starting up a power source will be explained. An electric power source is supplied from the access device 200 to the nonvolatile memory device 100 by attaching the nonvolatile memory device 100 to the access device 200. Then, the nonvolatile memory device 100 starts the initialization processing.

In the initialization processing, the reading-writing control part 124 creates the physical region management table 125 on the basis of block statuses stored in management regions of all physical blocks in the nonvolatile memory 110. Moreover, the reading-writing control part 124 creates the mapping table 126 on the basis of file numbers stored in the management regions of all physical blocks in the nonvolatile memory 110. Since a configuration of the physical block, for example, the management region is commonly known, an explanation thereof will be omitted here.

Processing of the capacity parameter generation part 127 will be explained. The capacity parameter generation part 127 executes the same processing also when the remote device 300 starts the data writing.

Referring to the physical region management table 125, the capacity parameter generation part 127 counts the number of physical blocks able to store new data. The counted number of physical blocks serves as a capacity parameter x. Specifically, the total number of blocks whose block statuses in the physical region management table 125 shown in FIG. 3 are the value “01” or the value “11” serves as the capacity parameter x. Here, the capacity parameter generation part 127 calculates a remaining capacity of the nonvolatile memory device 100 by multiplying the capacity parameter x by a physical block size (256 kB); the remaining capacity may serve as the capacity parameter. The capacity parameter is notified to the capacity parameter notification part 128 and is retained in the capacity parameter notification part 128.

The initialization processing now has been completed, however, the capacity parameter may be notified to the access device and the remote device in the initialization processing. After the aforementioned initialization processing, the nonvolatile memory device 100 is ready to read and write data from and to the access device 200 and the remote device 300.

[In Data Writing from the Remote Device]

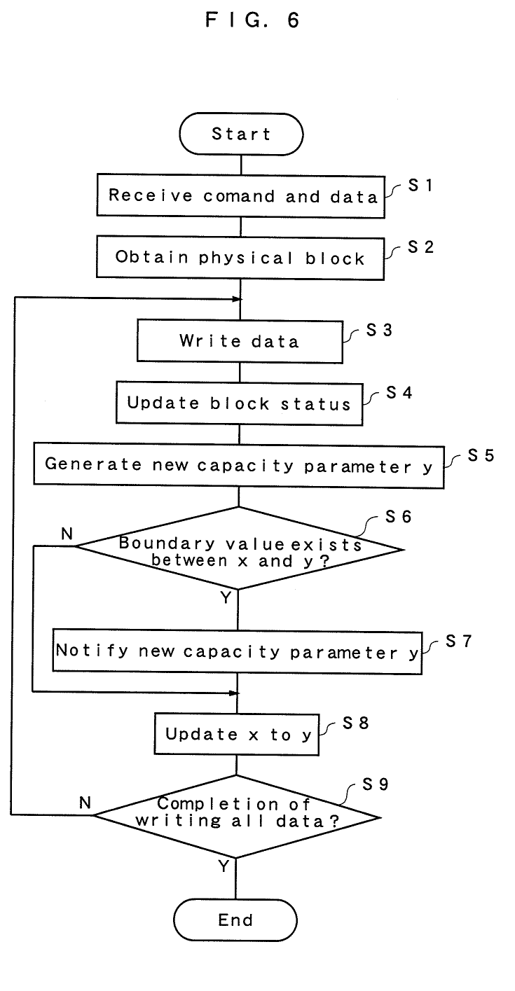

Processing for generating and notifying a capacity parameter when file data is written to the nonvolatile memory device 100 from the remote device 300 via the wireless communication channel 310 will be explained referring to FIG. 6. When the wireless communication IF 122 receives a writing command, file number, file size, and file data sent from the remote device 300 (S1), the wireless communication IF 122 notifies the reading-writing control part 124 of a writing-processing command via the IF detection part 123. Here, the file number is 1, and the file data indicated by the file number 1 is composed of four pieces of DATA 1 to DATA 4.

Referring to the physical region management table 125, the reading-writing control part 124 obtains four erased physical blocks used for recording DATA 1 to DATA 4 (S2). For example, the reading-writing control part 124 obtains the physical blocks PB9, PB25, PB41, and PB50. After obtaining the physical blocks, the reading-writing control part 124 stores, at a position of file number 1 in the mapping table 126, a physical block number of the physical block PB9, among the obtained four blocks, for storing DATA 1 that is starting file data. After that, the reading-writing control part writes DATA 1 to physical block PB9, and subsequently writes DATA 2 to 4 to physical blocks PB25, PB41, and PB50 in turn, respectively (S3).

The file data of file number 1 is stored in four physical blocks of starting PB9, PB25, PB41, and PB50. Thus, physical blocks PB25, PB41, and PB50 have to be associated to starting physical block PB9.

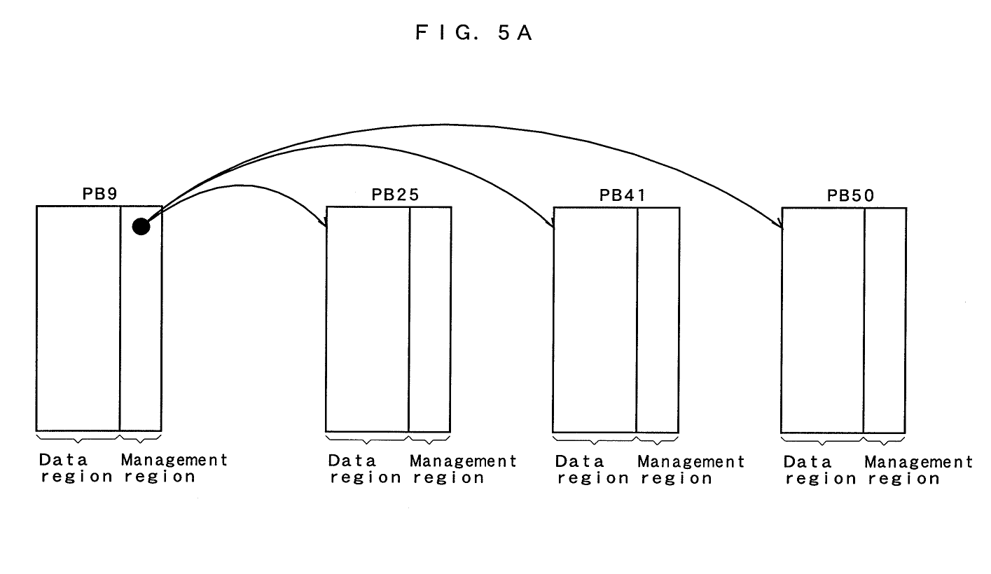

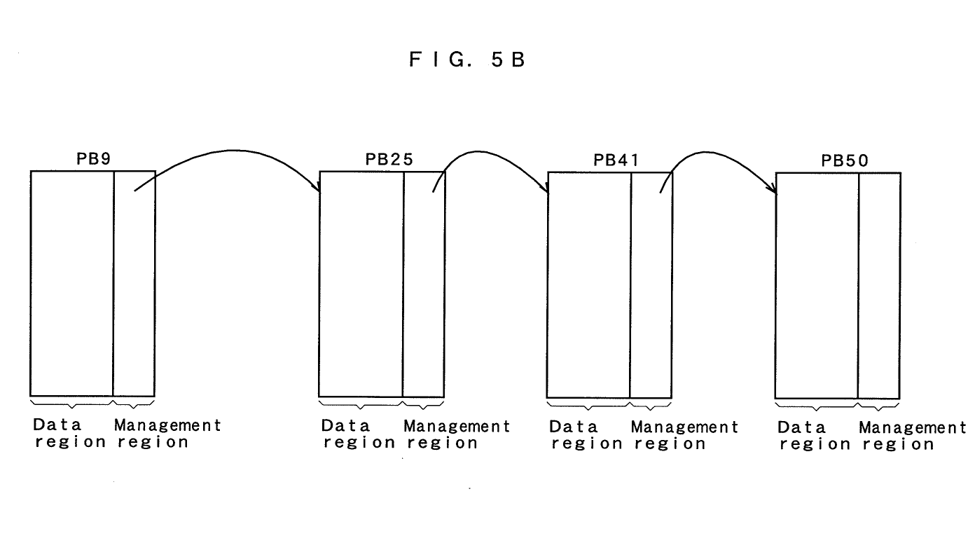

FIG. 5A and FIG. 5B are views showing a method for this association. FIG. 5A shows a method for storing a pointer indicating physical blocks PB25, PB41, and PB50 in a management region (a marked portion of black circle) of physical block PB9. In addition, FIG. 5B shows a method for storing pointers indicating next physical block number one after another from physical block PB9. Whichever methods can be employed, and in the embodiment the file number is associated with the stored data by using the mapping table 126 and information retained in a management region of a physical block.

Every time when the writing of file data is completed in units of physical blocks, the reading-writing control part 124 changes a block status of a written physical block in the physical region management table 125 to value “00” (S4).

Upon changing the block status in the physical region management table 151, the capacity parameter generation part 127 counts the number of physical blocks to which new data can be written with referring to the physical region management table 125 and notifies the capacity parameter notification part 128 of the counted number. The counted number of physical blocks serves as a new capacity parameter y (S5).

The capacity parameter notification part 128 receives the new parameter y generated by the capacity parameter generation part 127. The capacity parameter notification part 128 reads the retained capacity parameter x, and compares the new capacity parameter y and the capacity parameter x with a plurality of the preliminarily retained boundary values p(i) (S6). When at least one boundary value exists between the new capacity parameter y and the capacity parameter x, the capacity parameter notification part determines to notify the new capacity parameter y. When notifying the new capacity parameter y, the capacity parameter notification part notifies the interface 121 other than the wireless communication IF 122 of the new capacity parameter y (S7). After this notification, the capacity parameter x is updated to the new capacity parameter y (S8). When no boundary value exists between the new capacity parameter y and the capacity parameter x at step S6, the capacity parameter notification part 128 updates the capacity parameter x to the new capacity parameter y and stores the new parameter as a present capacity parameter to the capacity parameter notification part 128 proceeding to step S8 (S8). Upon completion of the update of capacity parameter, it is judged whether or not the writing of all file data is completed (S9). When the writing is completed, a series of the processing is completed, and when not completed, the processing returns to step S3 and next file data is written.

When receiving the capacity parameter from the capacity parameter notification part 128, the interface 121 notifies the interface 203 of the access device 200 of an interrupt.

The application 202 of the access device 200 waits until an interrupt is issued from the user IF 201 or the interface 203, and, when the interrupt is issued, analyzes a reason of the interrupt.

When the above-mentioned reason of the interrupt is analyzed as the notification of the new capacity parameter y from the nonvolatile memory device 100 via the interface 203, the application 202 obtains the new capacity parameter y, calculates a remaining capacity of the nonvolatile memory 110, and outputs the calculated remaining capacity. The user IF 201 displays the received remaining capacity.

A method carried out at step S6 for judging whether or not the new capacity parameter y must be notified will be explained below. In the judging method, it is judged whether or not a following expression (1) can be satisfied by, for example, each one of a plurality of the boundary value p(i) (i=0, 1, 2, . . . ) with using the capacity parameter x and the new capacity parameter y;

(x−p(i))×(y−p(i))<0 (1)

When at least one boundary value p(i) satisfying this expression (1) exists, it is determined to notify the new capacity parameter y because the boundary value exists between the capacity parameter x and the new capacity parameter y. According to this, when a value of the new capacity parameter y becomes smaller than a value of the capacity parameter x because of the writing of file data, change of the remaining capacity can be appropriately judged.

In addition, when file data is deleted, the value of the new capacity parameter y becomes larger than the value of the capacity parameter x because the number of physical blocks able to store new data increases. In such case, the change of the remaining capacity also can be appropriately judged by the method employing expression (1).

As described above, the nonvolatile memory system according to the embodiment counts the number of physical blocks able to store new data and updates the capacity parameter every time when the block status in the physical region management table 125 is changed.

In addition, when file data is written from the remote device 300 to the nonvolatile memory device 100, the nonvolatile memory device 100 notifies the access device 200 of a remaining capacity of the nonvolatile memory 110. The access device 200 accordingly can detect the change of the remaining capacity even when not carrying out the data writing by its own operation.

Meanwhile, in the embodiment, the capacity parameter notification part 128 retains the boundary value p(i) used for judging change of the capacity parameter, however, the boundary value may be designated from the access device 200 or the remote device 300.

The embodiment has described a case of notifying a remaining capacity parameter to the access device 200 when file data is written from the remote device 300. In the similar manner, when a file is written from the access device 200, the nonvolatile memory device also can notify the remote device 300 of a packet informing the remaining capacity parameter via the wireless communication channel 310.

According to such nonvolatile memory device, any file data recorded by the access device 200 or the remote device 300 can be equally read and deleted by the access device 200.

### Embodiment 2

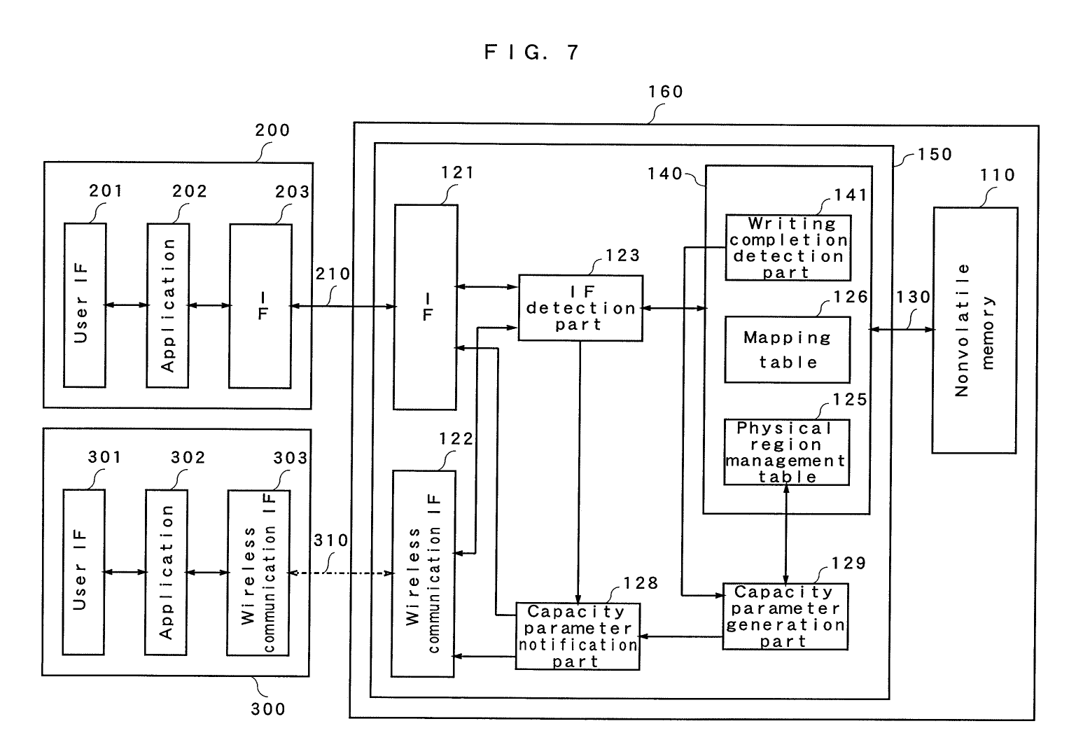

FIG. 7 is a block diagram showing a nonvolatile memory system according to embodiment 2 of the present invention. The nonvolatile memory system according to the present embodiment premises the “access method based on a file ID” same as embodiment 1. In the present embodiment, a file number is also used as the file ID.

Elements of the present embodiment different from those of embodiment 1 will be explained below. In a nonvolatile memory device 160 in the present embodiment, a memory controller 150 includes a reading-writing control part 140. The reading-writing control part 140 includes the physical region management table 125 and the mapping table same as those in embodiment 1 and further includes a writing completion detection part 141 characteristic in the present embodiment.

The writing completion detection part 141 detects completion of the writing of all file data sent from the access device 200 or the remote device 300, and notifies a capacity parameter generation part 129 of the completion of the writing of file data.

When the writing completion detection part 141 notifies the capacity parameter generation part 129 of the completion of the writing of file data, the capacity parameter generation part 129 generates the new capacity parameter y of the nonvolatile memory 110 by using the block statuses in the physical region management table 125 and outputs the generated parameter to the capacity parameter notification part 128.

An operation of the nonvolatile memory system according to the embodiment will be explained below.

### [Initialization Processing in Starting-Up a Power Source]

At first, initialization processing in starting-up a power source of the nonvolatile memory device 160 is the same as that of the nonvolatile memory device 110 in embodiment 1.

[In Writing Data from the Remote Device]

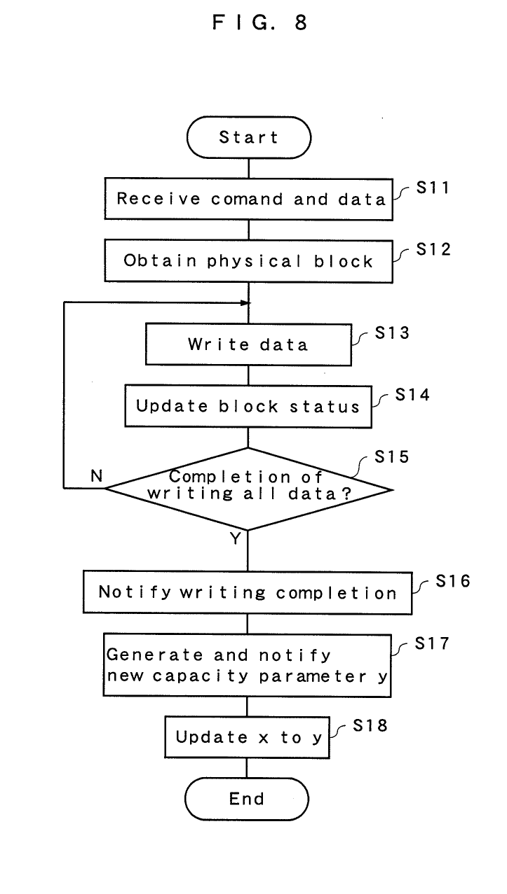

Next, processing for generating and notifying a capacity parameter when file data is written to the nonvolatile memory device 160 from the remote device 300 via the wireless communication channel 310 will be explained referring to FIG. 8. Similar to embodiment 1, when the wireless communication IF 122 receives a writing command, file number, file size, and file data sent from the remote device 300 (S11), the wireless communication IF 122 notifies the reading-writing control part 140 of a writing-processing command via the IF detection part 123. Accordingly, a physical block to store data is obtained (S12), and file data is written to the block (S13). Also in the present embodiment, the file number is 1, and the file data indicated by the file number 1 is composed of four pieces of DATA 1 to DATA 4 each corresponding to the physical block size.

For example, as shown in FIG. 5A, every time when the writing of file data is completed in units of physical blocks in turn from physical block PB9, a block status of a written physical block in the physical region management table 125 is changed to value “00” (S14).

Subsequently, it is judged whether or not last DATA 4 of file number 1 has been written to physical block PB50 (S15). When the writing of file data is not completed, the writing of file data is continued returning to step S13. When the writing of all file data of file number 1 is completed, the writing completion detection part 141 notifies the capacity parameter generation part 129 of the completion of the writing of file data (S16). Upon receiving this notification, the capacity parameter generation part 129 generates the new capacity parameter y in the manner same as that in embodiment 1 and notifies the capacity parameter notification part 128 of the generated parameter, and the capacity parameter notification part 128 notifies the access device 200 of the new capacity parameter y (S17). After this notification, the capacity parameter notification part 128 updates the capacity parameter x to the new capacity parameter y (S18), and stores the updated parameter as a present capacity parameter of the nonvolatile memory device 160.

The embodiment has described a case of notifying a remaining capacity parameter to the access device 200 when file data is written from the remote device 300. In the similar manner, when a file is written from the access device 200, the nonvolatile memory device also can notify the remote device 300 of a packet informing the remaining capacity parameter via the wireless communication channel 310.

In addition, a method for determining whether the new capacity parameter y is notified to the access device 200 or to the remote device 300 is the same as that in embodiment 1. The determination at S15 and S16 as to whether or not the new capacity parameter y is notified may be based on the comparison using the boundary value p(i) described in embodiment 1.

As described above, since the nonvolatile memory system according to the present embodiment generates the capacity parameter of the nonvolatile memory 110 at each completion of the writing of file data belonging to one file number, the access device 200 or the remote device 300 can display an accurate remaining capacity of the memory.

Meanwhile, also in the present embodiment, the access device 200 and the remote device 300 can display an accurate remaining capacity of the nonvolatile memory 110 even when the number of valid blocks increases because of deletion of file data.

Embodiments 1 and 2 have been described with showing the external bus 210 connecting to the access device 200 as an example of an external interface of the nonvolatile memory devices 100 and 160, however, an SD bus or a USB bus may be employed as the interface. Moreover, any of appropriate channels, for example, a wireless LAN (IEEE802.11), a UWB, a Bluetooth, a mobile phone network, and a contactless IC may be employed as the wireless communication channel 310 connecting to the remote device 300. Furthermore, in the nonvolatile memory device 100 or 160, the external bus 210 and the wireless communication channel 310 are not limited to be single as shown in the embodiments of the present invention. The present invention can be applied to a case where the device has more than one external bus 210 and more than one wireless communication channel 310 and a case where the device has a plurality of the external buses or a plurality of the wireless communication channels.

Additionally, the capacity parameter notification part 128 does not notify a writing device detected by the IF detection part 123 of a capacity parameter in embodiments 1 and 2 of the present invention, however, the present invention may have a configuration for notifying all wired and wireless access devices connected to the nonvolatile memory devices 100 and 160 of the capacity parameter.

### INDUSTRIAL APPLICABILITY

The nonvolatile memory system according to the present invention is useful for a still image recording and reproducing device, a moving image recording and reproducing device, and a mobile phone each employing a nonvolatile memory device having a plurality of access interfaces including a wireless communication interface and the like.

1. A memory controller which is connected to a nonvolatile memory having a plurality of physical blocks of a data erasing unit, and writes and reads data to and from said nonvolatile memory in accordance with a file ID designated from an outside, comprising:
at least two external interfaces;
a capacity parameter generation part for generating a capacity parameter related to a remaining capacity of said nonvolatile memory in writing data to said nonvolatile memory and deleting data in said nonvolatile memory via one of said external interfaces and in initialization; and
a capacity parameter notification part for retaining the capacity parameter generated by said capacity parameter and notifying the outside of the capacity parameter via at least the other external interface.

2. The memory controller according to claim 1, wherein
at least one of said external interfaces is a wireless communication interface for sending and receiving data by wireless communication.

3. The memory controller according to claim 1, further comprising:
a mapping table for relating said file ID to said physical block.

4. The memory controller according to claim 1, wherein:
said memory controller further comprises a reading-writing control part having a physical region management table representing a use state of said nonvolatile memory;
said capacity parameter generation part generates a capacity parameter by using said physical region management table; and
said capacity parameter notification part has a reference value used for detecting a certain amount of change of the capacity parameter and notifies an outside of said generated capacity parameter when said generated capacity parameter changes exceeding said reference value from the retained capacity parameter.

5. The memory controller according to claim 1, wherein:
said memory controller further comprises a reading-writing control part having a physical region management table representing a use state of said nonvolatile memory and a writing completion detection part for detecting completion of file data writing; and
said capacity parameter generation part generates a capacity parameter by using said physical region management table when said writing completion detection part detects said completion of file data writing.

6. A nonvolatile memory device which comprises: a nonvolatile memory having a plurality of physical blocks of a data erasing unit; and a memory controller, and stores and reads data in accordance with a file ID designated from an outside, wherein
said memory controller includes:
at least two external interfaces;
a capacity parameter generation part for generating a capacity parameter related to a remaining capacity of said nonvolatile memory in writing data to said nonvolatile memory and deleting data in said nonvolatile memory both via one of said external interfaces and in initialization; and
a capacity parameter notification part for retaining the capacity parameter generated by said capacity parameter and notifying the outside of the capacity parameter via at least the other external interface.

7. The nonvolatile memory device according to claim 6, wherein
at least one of said external interfaces is a wireless communication interface for sending and receiving data by wireless communication.

8. The nonvolatile memory device according to claim 6, further comprising:
a mapping table for relating said file ID to said physical block.

9. The nonvolatile memory device according to claim 6, wherein:
said memory controller further includes: a reading-writing control part having a physical region management table representing a use state of said nonvolatile memory;
said capacity parameter generation part generates a capacity parameter by using said physical region management table; and
said capacity parameter notification part has a reference value used for detecting a certain amount of change of the capacity parameter and notifies an outside of said generated capacity parameter when said generated capacity parameter changes exceeding said reference value from the retained capacity parameter.

10. The nonvolatile memory device according to claim 6, wherein:
said memory controller further includes: a reading-writing control part having a physical region management table representing a use state of said nonvolatile memory and a writing completion detection part for detecting completion of file data writing; and
said capacity parameter generation part generates a capacity parameter by using said physical region management table when said writing completion detection part detects said completion of file data writing.

11. A nonvolatile memory system comprising: a plurality of access devices; and a nonvolatile memory device for storing and reading data in accordance with a file ID designated from said access device, wherein:
said nonvolatile memory device includes: a nonvolatile memory having a plurality of physical blocks of data erasing units; and a memory controller; and
said memory controller includes:
a plurality of external interfaces connected to said each access device;
a capacity parameter generation part for generating a capacity parameter related to a remaining capacity of said nonvolatile memory when any one of said access devices writes data to said nonvolatile memory and deletes data in said nonvolatile memory both via one of said external interfaces and when initialization is executed; and
a capacity parameter notification part for retaining the capacity parameter generated by said capacity parameter and notifying other access device of the capacity parameter via at least the other external interface.

12. The nonvolatile memory system according to claim 11, wherein
at least one of said external interfaces of the memory controller is a wireless communication interface for sending and receiving data by wireless communication.

13. The nonvolatile memory system according to claim 12, wherein
at least one of said access devices is a remote device for sending and receiving data by wireless communication.

14. The nonvolatile memory system according to claim 11, wherein
said memory controller further includes: a mapping table for relating said file ID to said physical block.

15. The nonvolatile memory system according to claim 11, wherein:
said memory controller further includes: a reading-writing control part having a physical region management table representing a use state of said nonvolatile memory;
said capacity parameter generation part generates a capacity parameter by using said physical region management table; and
said capacity parameter notification part has a reference value used for detecting a certain amount of change of the capacity parameter and notifies said access device of said generated capacity parameter when said generated capacity parameter changes exceeding said reference value from the retained capacity parameter.

16. The nonvolatile memory system according to claim 11, wherein:
said memory controller further includes: a reading-writing control part having a physical region management table representing a use state of said nonvolatile memory and a writing completion detection part for detecting completion of file data writing; and
said capacity parameter generation part generates a capacity parameter by using said physical region management table when said writing completion detection part detects said completion of file data writing.

17. An access device used by being connected to a nonvolatile memory device having at least two external interfaces and a nonvolatile memory, wherein
said access device reads and writes data by designating a file ID to said nonvolatile memory device, receives a capacity parameter from said nonvolatile memory device, and calculates a remaining capacity of said nonvolatile memory device by using said capacity parameter.

18. The access device according to claim 17, wherein
said access device sends and receives data by wireless communication.
